(19) United States
(12) Patent Application Publication
(10) Pub. No.: US 2008/0229314 A1
(43) Pub. Date: Sep. 18, 2008

(54) STORAGE MEDIUM CONTAINING BATCH PROCESSING PROGRAM, BATCH PROCESSING METHOD AND BATCH PROCESSING APPARATUS

(75) Inventors: Atsuhito Hirose, Kawasaki (JP); Masaaki Mori, Kawasaki (JP); Toshihiro Suzuki, Kawasaki (JP); Kazunori Kobashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/037,327

(22) Filed: Feb. 26, 2008

(30) Foreign Application Priority Data
Mar. 16, 2007 (JP) 2007-069165

(51) Int. Cl. G06F 9/46

(52) U.S. Cl. 718/102

(57) ABSTRACT

Batch processing program is performed in a computer. Job steps are executed in a manner that, when the number of job steps is determined by the determining means to exceed the maximum number of processes, successive job steps defined as pipe processing objects are divided in units of a maximum number of job steps corresponding to the maximum number of processes. A pipe is used for data transfer between respective job steps within a same segment divided, and a temporary file is used for data transfer between each set of adjacent job steps each belonging to a different segment.

When the number of job steps is determined by the determining means to not exceed the maximum number of processes, a pipe is used for data transfer between respective job steps of all of the successive job steps defined as the pipe processing objects.

### BACKGROUND OF THE INVENTION

1. Technical Field

In pipe processing, all job steps connected by pipes (“by-pipe connected to,” herebelow) to one another, that is, ail job steps for performing data transfer by using pipes, have to be synchronously executed. When processing a batch job including a large number of job steps, the pipe processing has to execute a number of processes exceeding the processing capacity of a computer.

When a number of processes exceeding the processing capacity of the computer are executed, there occurs increase in swap because CPU capacity shortage occurs and the amount of memory used exceeds a maximum value. Consequently, the process efficiency is reduced in the event the pipe processing is not executed. Further, the operation of the computer becomes unstable.

As such, there arises a problem in that the technique of pipe processing cannot be practically applied for a batch job in which the number of job steps exceeds a number of processes synchronously executable in the computer.

The present invention relates to a technique for solving this problem.

### SUMMARY

According to one aspect of the present invention, there is provided a batch processing apparatus including a batch job definition file; storing means having stored thereon a maximum number of processes synchronously executable; reading means for reading the batch job definition file; determining means for determining whether or not a number of job steps defined in the batch job definition file as pipe processing objects in the batch job definition file exceeds the maximum number of processes stored in the storing device; and first, executing means for executing job steps in a manner that, when the number of job steps is determined by the determining device to exceed the maximum number of processes, successive job steps defined as pipe processing objects are divided in units of a maximum number of job steps corresponding to the maximum number of processes. A pipe is used for data transfer between respective job steps within a same segment that has been divided, and a temporary file is used for data transfer between each set of adjacent job steps each belonging to a different segment. Second executing means are provided for executing job steps in a manner that, when the number of job steps is determined by the determining device to not exceed the maximum number of processes, a pipe is used for data transfer between respective job steps of all of the successive job steps defined as the pipe processing objects.

### BRIEF DESCRIPTION OF THE DRAWINGS

FIG. 1 is a functional overview of a batch processing apparatus;

FIG. 2 is an explanatory view of a JCL file for pipe processing;

FIG. 3 is an explanatory view of batch processing;

FIG. 4 is an explanatory view of correlation between job steps and input and output files;

FIG. 5 is a flow chart showing an execution control process;

FIGS. 6A and 6B are flow charts showing a partial pipe connection process;

FIG. 7 is a flow chart showing a total pipe connection process;

FIG. 8 is an explanatory view of a job step input and output table;

FIG. 9 is an explanatory view of a JCL file for parallel processing; and

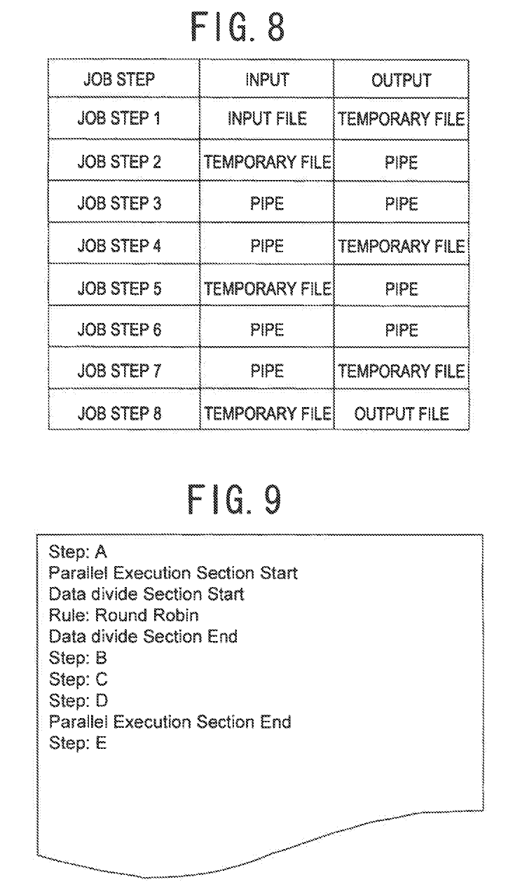

FIG. 10 is an explanatory view of the parallel processing.

### DETAILED DESCRIPTION OF THE PREFERRED EMBODIMENT

A preferred embodiment of the present invention will be described in detail with reference to practical embodiments and/or examples of the invention in accordance with the accompanying drawings.

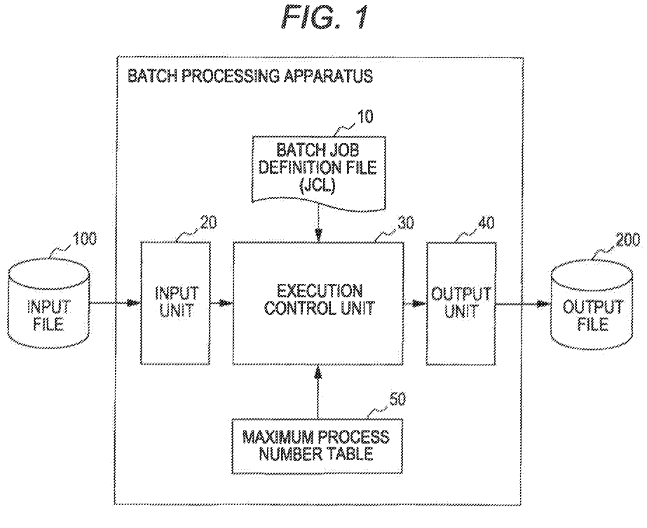

FIG. 1 is a functional overview of a batch processor. The batch processor is configured to a computer equipped with at least a central processing unit (CPU) and a memory.

The batch processor is configured to include a batch job definition file 10 (“JCL file” (JCL: job control language), hereinbelow). An input unit 20 inputs data from an input file 100, and an execution control unit 30 performs execution control of a batch job. An output unit 40 outputs data output as an execution result of a batch job to an output file 200, and a maximum process number table 50 retains a maximum number of processes executable at the same time by the computer, or more specifically, the number of by-pipe connectable job steps.

Having accepted a batch job and read the JCL file 10, the execution control unit 30 executes the batch job with the use of data input from the input unit 20, in accordance with a control statement defined in the JCL file 10. In this event, the execution control unit 30 first references a maximum number of processes in the maximum process number table 50. The maximum number of processes in the maximum process number table 50 is a value dynamically rewritten corresponding to the operational status of a server, and is stored in memory or the like. For example, assume that the maximum number of processes is exceeded by the number of a stream of successive job steps defined in the JCL file 10 to undergo pipe processing (or to be “pipe-processed”), i.e., the number of job steps defined as pipe processing objects. In such a case, the execution control unit 30 divides a stream of successive job steps on the basis of a maximum number of job steps corresponding to the maximum number of processes as one segment. The execution control unit 30 uses pipes for data transfer between respective job steps in the same segment. In addition, the execution control unit 30 uses temporary files for data transfer between job steps across segments. On the other hand, when the maximum number of processes is not exceeded by the number of job steps defined as pipe processing objects, the execution control unit 30 executes the job steps using pipes for transfer of data of ail of the job steps. The output unit 40 outputs to the output file 200 data, produced as an execution result of the batch job. The above-described processes executed by or under the control of the execution control unit 30 correspond to reading means, reading step, determining means, determining step, first executing means, first executing step, second executing means, and second executing step in the appended claims.

The processes described above will be described herebelow with reference to a practical example.

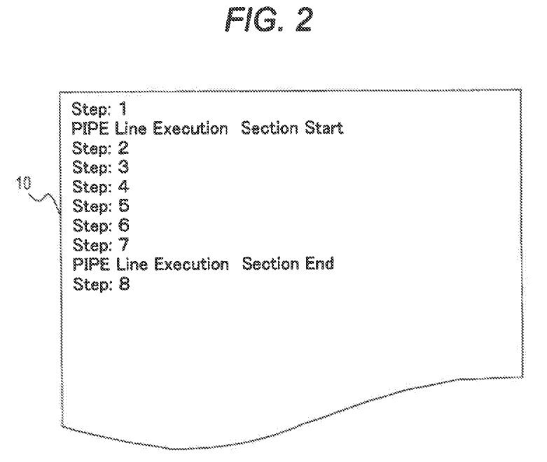

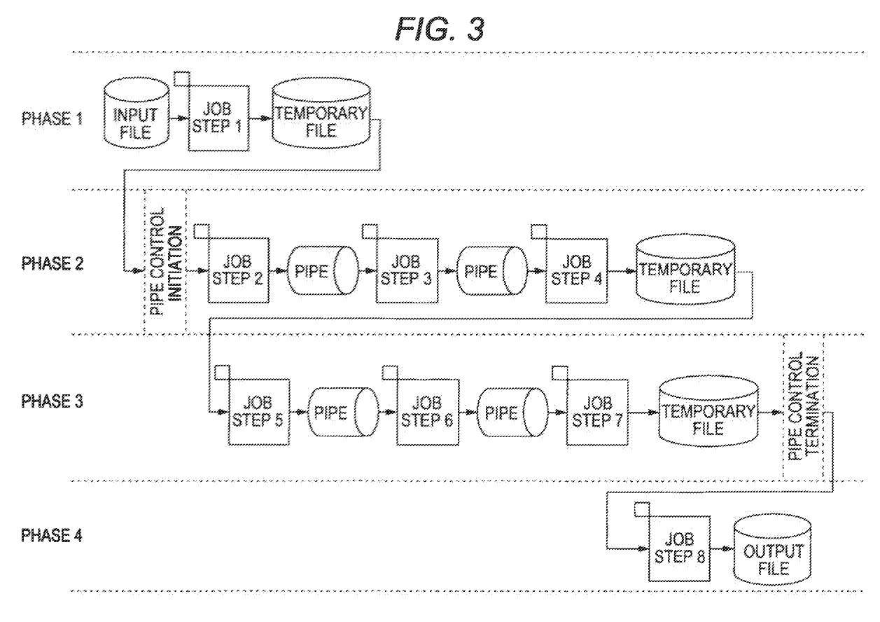

For example, it is assumed that a definition shown in FIG. 2 is provided in the JCL file 10. The JCL file 10 is used for control of pipe processing of six job steps, namely from job step 2 (“Step 2” in the third line) to job step 7 (“Step 7” in the eighth line) between a control statement (the second line) for starting the control of pipe processing and a control statement (ninth line) for ending the control of pipe processing. Further, it is assumed that “3” is defined as the maximum number of processes in the maximum process number table 50. In this event, when having received a batch job, the execution control unit 30 executes processes shown in FIG. 3 in accordance with the JCL file 10 and the maximum process number table 50. More specifically, the execution control unit 30 operates as described hereinbelow. A job step 1 undefined as a non-pipe processing object is executed with the use of data having been input from the input file 100 through the input unit 20, and data for transfer to a job step 2 is stored into a temporary file (phase 1). In the present case, it is assumed that the number of job steps defined as pipe processing objects is six, and the number exceeds a maximum number of processes of three. As such, of job steps 2 to 7 defined as pipe processing objects, up to three job steps corresponding to the maximum number of processes set in the maximum process number table 50, namely the job steps 2 to 4, are separated or divided as one segment. As described above, pipes are used for data transfer across these job steps. The segment with the job step 4 and a segment with a job step 5 are different from one another, and the temporary file is used for data transfer therebetween (phase 2). Similarly, a group of the job steps 5 to 7 are divided as one segment, and are by-pipe connected to one another. A temporary file is used between the job step 7 and a job step 8 for data transfer (phase 3). Then, the job step 8 is executed, and data output, as the execution result is output from the output unit 40 to the output file 200 (phase 4).

Suppose that, in the example of the JCL file 10 shown in FIG. 2, the maximum number of processes is six or greater; that is, the number of job steps defined as pipe processing objects does not exceed the maximum number of processes. In this case, all the job steps 2 to 7 defined as pipe processing objects are by-pipe connected to one another, in which respective pipes are used for data transfer.

The correlation between a temporary file, pipe, job step, and an input and output of the job step will be described herebelow. In this regard, the execution control unit 30 operates as follows. In accordance with the JCL file 10 and the maximum process number table 50, the execution control unit 30 determines whether each of the input and output of the respective job step is a temporary file or pipe. The execution control unit 30 generates a temporary file or pipe with an input object name or output object name preliminarily defined in the JCL file 10. The job step executing process enables input and output to be performed using the temporary file and pipe in the manner that the job step is correlated with the input and output object names as environmental variables.

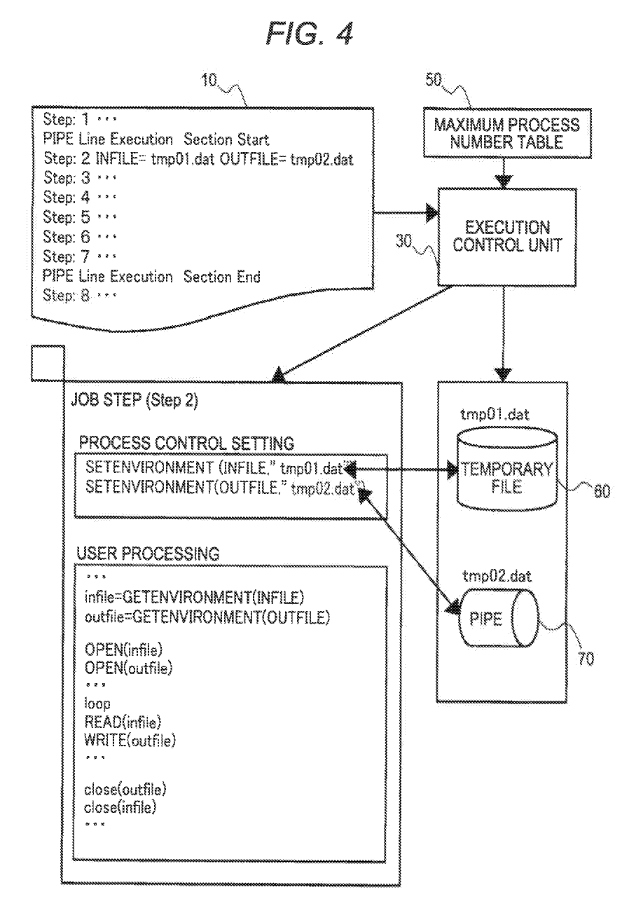

For example, in the case of the process shown in FIG. 3, the execution control unit 30 connects by pipe the job steps 2 to 4 and 5 to 7 to one another. As attention is paid to the job step 2, it can be known that the input object is the temporary file and the output object is the pipe. FIG. 4 is an explanatory view showing a practical example of correlation in the case of the job step 2. In this case, it is assumed that the input object name and the output object name, respectively, are defined as “tmp01.dat” and “tmp02.dat” in the JCL file 10 (third line). Before the execution of the job step 2, the execution control unit 30 generates a temporary file 60 for the input of the job step 2 in the name of “tmp01.dat” and a pipe 70 for the output in the name of “tmp02.dat” in accordance with the definitions in the JCL file 10. In addition, the execution control unit 30 operates to provide control settings. The process for executing the job step 2 sets the respective the environmental variables of the input object name and output object name to “tmp01.dat” and “trap02.dat”. Thereby, a user who performs practical processing of the job step 2 can perform the processing with the use of the temporary file 60 and pipe 70 correlated in accordance with the environmental variables.

A case can take place in which such input and output object names are not defined in the JCL file 10. Even in such a case, the execution control unit 30 can generate a temporary file or pipe in an input or output object name appropriately determined at the execution time. Thereby, the input or output of the respective job step in the job step processing on the side of the user can be correlated with the temporary file or pipe through an input/output control function mounted in a general operating system.

Processes and/or processing to be executed under the control of and/or by the execution control unit 30 will foe described in more detail herebelow.

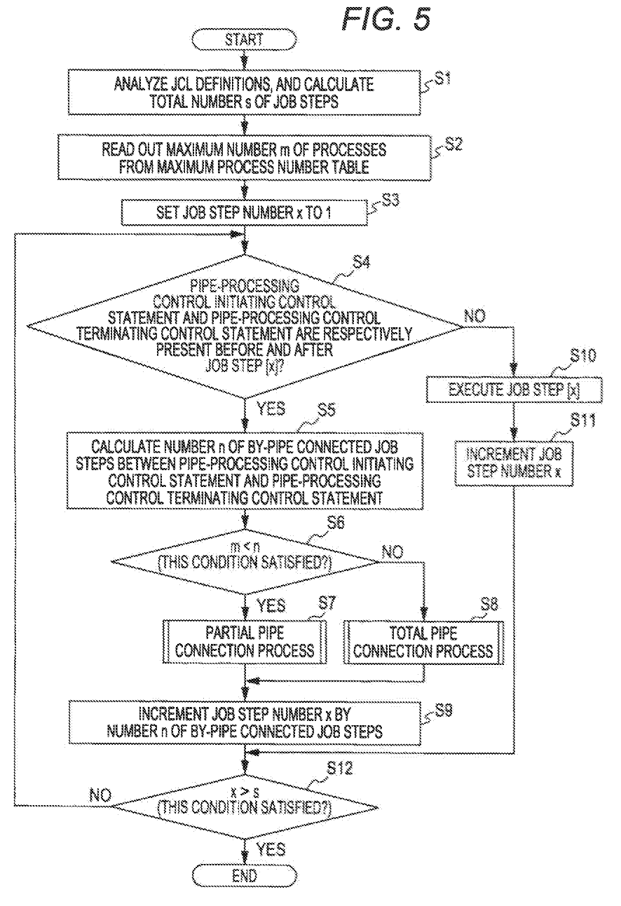

FIG. 5 is a flow chart showing the contents of an execution control process (or simply, “control process,” hereinbelow). The execution control process is started upon receipt of a batch job in the execution control unit 30, that is, when the JCL file 10 is read by the execution control unit 30.

The execution control process is executed in the following manner (in description hereinbelow and drawings, the respective processing step is represented as “step Sn” or “Sn”(n=number). At step S1, a JCL description read out from the JCL file 10 is analyzed, and a total number s of job steps is calculated. Step S1 corresponds to the reading means and the reading step in the appended claims.

At step S2, the execution control process reads out a maximum number m of processes from the maximum process number table 50.

At step S3, the execution control process sets a job step number x to 1. The job step number x is indicative of the sequential position of a respective job step.

At step S4, the execution control process determines whether or not a condition is satisfied. The condition is that “a control statement for starting control of pipe processing (or, “pipe-processing control initiating control statement,” herebelow) is present before a job step [x], which is an x-th job step (similar presentation manner will be used for other job steps below), and concurrently, a control statement for terminating control of pipe processing (or, “pipe-processing control terminating control statement,” herebelow) is present after the job step.” If the condition (that is, the condition that the pipe-processing control initiating and terminating control statements are, respectively, present before and after the job step [x]) is satisfied (determination result=“YES” (affirmative answer)), then the control process proceeds to step S5. Otherwise, if the condition is not satisfied (determination result=“NO” (negative answer)), then the control process to step S10.

At step S5, the execution control process calculates a number n of by-pipe connected job steps defined in the JCL file 10. The number n represents the number of job steps present between the pipe-processing control initiating and terminating control statements.

At step S6, the execution control process determines whether the maximum number m of processes is smaller than the number n of by-pipe connected job steps. If the maximum number m of processes is smaller than the number n of by-pipe connected job steps (i.e., if the determination result=“YES”), then the control process proceeds to step S7. Otherwise, if the condition that the maximum number m of processes is greater than or equal to the number n of by-pipe connected job steps (i.e., if the determination result=“NO”), then the control process proceeds to step 88. Step S6 described above corresponds to determining means and determining step in the appended claims.

At step S7, the execution control process calls a subroutine for a partial pipe connection process. In this case, the maximum number m of processes and the number n of by-pipe connected job steps are passed as respective arguments to the subroutine.

At step S8, the execution control process calls a subroutine for a total pipe connection process. In this case, the maximum number m of processes and the number n of by-pipe connected job steps are passed as the respective arguments to the subroutine.

At step S9, the execution control process increments the job step number x by the number n of by-pipe connected job steps.

At step S10, the execution control process executes the job step [x].

At step S11, the execution control process increments the job step number x.

At step S12, the execution control process determines whether or not the job step number x is greater than the total number s of job steps. If the condition that the job step number x is greater than the total number s of job steps is satisfied (i.e., if the determination result=“YES”), then the control process terminates. Otherwise, if the condition that the job step number x is smaller than or equal to the total number s of job steps (i.e., if the determination result=“NO”), then the control process returns step S4.

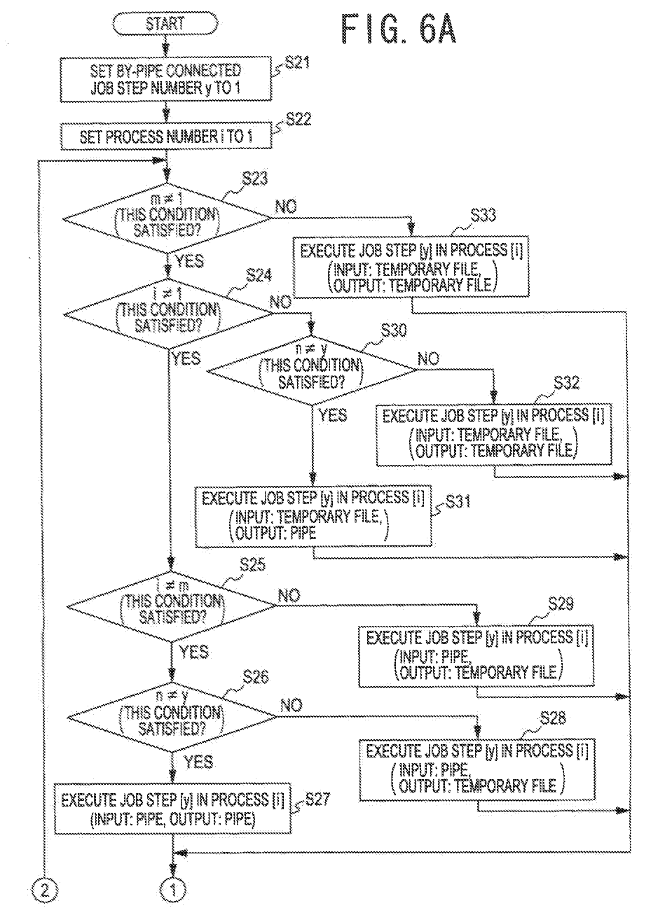

FIGS. 6A and 6B show are a flow chart showing the processing contents of the subroutine for the partial pipe connection process called by the execution control process. The partial pipe connection process is executed when the number of job steps defined as pipe processing objects defined in the JCL file 10 exceeds the maximum number m of processes. In this case, the maximum number m of processes and number n of by-pipe connected job steps are received as the respective arguments from the execution control process.

At step S21, the partial pipe connection process sets a by-pipe connected job step number y to 1. The by-pipe connected job step number y is indicative of the sequential position of the job step in the partial pipe connection process.

At step S22, the partial pipe connection process sets a process number i to 1. The process number i is indicative of the number of processes corresponding to the number of job steps being synchronously executed in the partial pipe connection process.

At step S23, the partial pipe connection process determines whether or not the condition that the maximum number m of processes is not 1 (i.e., whether or not m≠1). If the condition that the maximum number m of processes is not 1 is satisfied (i.e., if the determination result=“YES” (i.e., when m≠15), the control process proceeds to step S24. Otherwise, if the condition that, the maximum number m of processes is not 1 is not satisfied (i.e., if the determination result=“NO” (i.e., when m=1)), the control process proceeds to step S33.

At step S24, the partial pipe connection process determines whether or not the process number i is not 1 (i.e., whether or not i≠1). If the condition that the process number i is not 1 is satisfied (i.e., if the determination result=“YES” (.i.e., when i≠1)), then the control process proceeds to step S25. Otherwise, if the condition that process number i is not 1 is not satisfied (i.e., if the determination result=“NO” (i.e., when i=1)), then the control process proceeds to step S30.

At step S25, the partial pipe connection process determines whether or not the process number i is different from the maximum number m of processes. If the condition that the process number i is different from the maximum number m of processes is satisfied (i.e., if the determination result=“YES”), then the control process proceeds to step S26. Otherwise, if the condition that the process number i is different from the maximum number m of processes is not satisfied (i.e., if the determination result=“NO”), then the control process proceeds to step S29.

At step S26, the partial pipe connection process determines whether or not the number n of by-pipe connected job steps is different from the by-pipe connected job step number y (i.e., whether or not n≠y). If the condition that the number n of by-pipe connected job steps is different from the by-pipe connected job step number y is satisfied (i.e., if the determination result=“YES” (i.e., when n≠1)), then the control process proceeds to step S27. Otherwise, if the condition that the number n of by-pipe connected job steps is different from the by-pipe connected job step number y is not satisfied (i.e., if the determination result=“NO” (i.e., when n=y)), then the control process proceeds to step S28.

At step S27, the partial pipe connection process executes a job step [y] in a process [i]. In this case, data input is performed from a pipe, and data output is performed to a pipe.

At step S28, the partial pipe connection process executes the job step [y] in the process [i]. In this case, data input is performed from the pipe, and data output is performed to a temporary file.

At step S29, the partial pipe connection process executes the job step [y] in the process [i]. In this case, data input is performed from the pipe, arid data output is performed to the temporary file.

At step S30, the partial pipe connection process determines whether or not the number n of by-pipe connected job steps is different from the by-pipe connected job step number y (i.e., whether or not n≠y). If the condition that the number n of by-pipe connected job steps is different from the by-pipe connected job step number y is satisfied (i.e., if the determination result=“YES” ((i.e., when n≠y)), then the control process proceeds to step S31. Otherwise, if the condition that the number n of by-pipe connected job steps is different from the by-pipe connected job step number y is not satisfied (i.e., if the determination result=“NO” (i.e., when n=y), then the control process proceeds to step S32.

At step S31, the partial pipe connection process executes the job step [y] in the process [i]. In this case, data input is performed from a temporary file, and data output is performed to a pipe.

At step S32, the partial pipe connection process executes the job step [y] in the process [i]. In this case, data input is performed from the temporary file, and data output is performed to a temporary file.

At step S33, the partial pipe connection process executes the job step [y] in the process [i]. In this case, data input is performed from the temporary file, and data output is performed to the temporary file.

At step S34, the partial pipe connection process increments the respective by-pipe connected job step number y and process number i.

At step S35, the partial pipe connection process determines whether or not a condition that “the process number i is greater than the maximum number m of processes (i.e., whether i>m) or by-pipe connected job step number y is greater than the number n of by-pipe connected job steps (i.e., whether or not y>n) “is satisfied. If the condition is satisfied (i.e., if the determination result=“YES” (i.e., when i>m, and y>n)), then the control process proceeds to step S36. Otherwise, if the condition is not satisfied (i.e., if the determination result=“NO”), then the control process returns to step S23.

At step S36, the partial pipe connection process enters a standby mode awaiting termination of all job steps being executed in processes [1] to [m].

At step S37, the partial pipe connection process determines whether or not the process number i is smaller than or equal to the maximum number m of processes. If the process number i is smaller than or equal to the maximum number m of processes (i.e., if the determination result=“YES” (i.e., when i≦m)), then the control process proceeds to step S38. Otherwise, if the process number i is greater than the maximum number m of processes (i.e., if the determination result=“NO” (i.e., when i>m)), then the control process proceeds to step S39.

At step S38, the partial pipe connection process determines whether or not the by-pipe connected job step number y is greater than the number n of by-pipe connected job steps (i.e., whether y>n). If the by-pipe connected job step number y is greater than the number n of by-pipe connected job steps (i.e., if the determination result=“YES” (i.e., when y>n)), then the control process terminates. Otherwise, if the by-pipe connected job step number y is smaller than or equal to the number n of by-pipe connected job steps (i.e., if the determination result=“NO” (i.e., when y≦n)), the control process returns to step S23.

At step S39, the partial pipe connection process sets the process number i to 1.

The partial pipe connection process thus described corresponds to first executing means and first executing step in the appended claims.

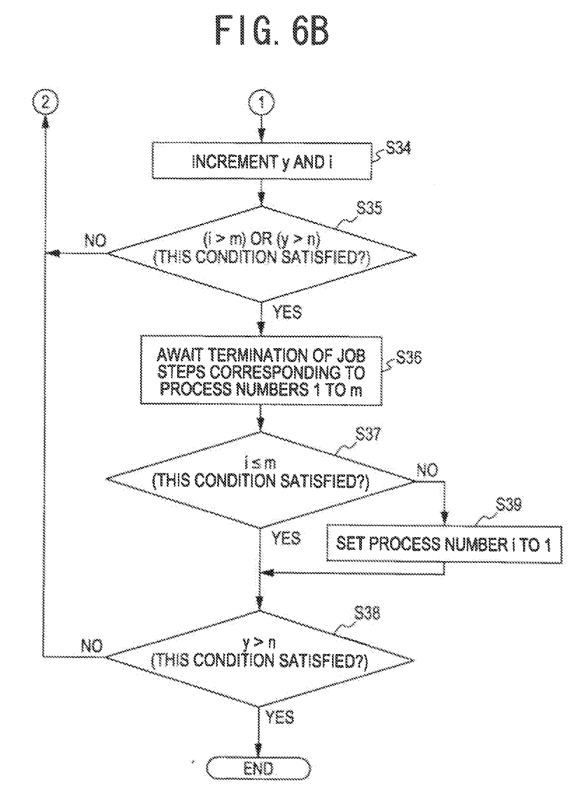

FIG. 7 is a flow chart showing the contents of the total pipe connection process called by the execution control process. The total pipe connection process is executed, when the number of job steps defined as pipe processing objects defined in the JCL file 10 does not exceed the maximum number m of processes. In this case, the maximum number m of processes and number n of by-pipe connected job steps are received as the respective arguments from the execution control process.

At step S41, the total pipe connection process sets a by-pipe connected job step number z to 1. The by-pipe connected job step number z is indicative of the sequential position of the job step in the total pipe connection process.

At step S42, the total pipe connection process sets a process number j to 1. The process number j is indicative of the number of processes corresponding to the number of job steps being synchronously executed in the total pipe connection process.

At step S43, the total pipe connection process determines whether or not the maximum number m is not equal to 1 (i.e., whether or not m≠1), and concurrently, the number n of by-pipe connected job steps is not equal to 1 (i.e., whether or not n≠1). If the condition is satisfied (i.e., if the determination result=“YES” (i.e., when m≠1, and n≠1)), then the control process proceeds to step S44. Otherwise, if the condition is not satisfied (i.e., if the determination result=“NO” (i.e., when m=1, and n=1)), then the control process proceeds to step S50,

At step S44, the total pipe connection process executes a job step [z] in a process [j]. In this case, data input is performed from a temporary file, and data output is performed to a pipe.

At step S45, the total pipe connection process increments the respective by-pipe connected job step number z and process number j.

At step S46, the total pipe connection process determines whether or not the by-pipe connected job step number z is smaller than the number n of by-pipe connected job steps (i.e., whether or not z=n). If the by-pipe connected job step number z is smaller than the number n of by-pipe connected job steps (i.e., if the determination result=“YES” (i.e., when z<n)), then the control process proceeds to step S47. Otherwise, if the by-pipe connected job step number z is greater than or equal to the number n of by-pipe connected job steps (i.e., if the

determination result=“NO” (i.e., when z≧n)), then the control process proceeds to step S49.

At step S47, the total pipe connection process executes the job step [z] in the process [j]. In this case, data input is performed from the pipe to another pipe.

At step S48, the total pipe connection process increments the respective by-pipe connected job step number z and process number j.

At step S49, the total pipe connection process executes the job step [z] in the process [j] . In this case, data input is performed from the pipe to a temporary file.

At step S50, the total pipe connection process executes the job step [z] in the process [j]. In this case, data input is performed from the temporary file to a temporary file.

The total pipe connection process thus described corresponds to second executing means and second executing step in the appended claims.

In summary, the execution control process and partial pipe processing operate as follows. In the event of execution of job steps defined as pipe processing objects in the JCL file 10, the maximum number of processes in the maximum process number table 50 are referenced, and it is determined whether or not the number of job steps defined as pipe processing objects exceeds the maximum number of processes. When the number of job steps defined as pipe processing objects exceeds the maximum number of processes, the following process is executed. That is, of a stream of successive job steps, a number of job steps up to a maximum number of job steps corresponding to the maximum number of processes are divided as one segment (of job seeps), and the job steps are sequentially by-pipe connected to one another within the segment. Then, the temporary file is used for data transfer between the last one of the by-pipe connected job steps and a subsequent job step, chat is, data transfer between job steps divided into different segments. On the other hand, however, when the number of job steps defined as pipe processing objects does not exceed the maximum number of processes, all the job steps defined as pipe processing objects are each executed by using the pipe. Thus, in the execution of data transfer between job steps, the pipes and temporary files are used in combination, and job steps are by-pipe connected to one another only within the range of the maximum number of processes that can be synchronously executed in the server. Thereby, both high speed and stabilized operational capabilities of batch processing can be accomplished.

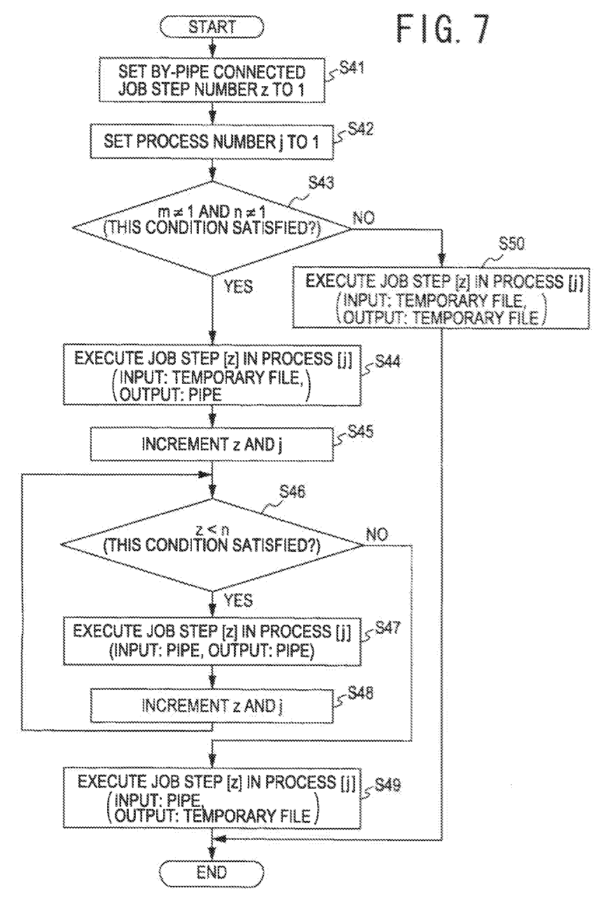

The processing of the execution control unit 30 may be as follows. Before job step execution, an input and output table, as shown in FIG. 8 is generated in accordance with the JCL file 10 and the maximum process number table 50. The table contains definitions each specifying whether input or output of each of the job steps is performed using one of the temporary file or pipe is generated in accordance with the JCL file 10 and the maximum process number table 50, and the job steps are sequentially executed in accordance with the generated table.

As an alternative technique similar to pipe processing capable of improving the speed of batch processing, parallel processing in which a plurality of identical job steps are arranged in parallel and executed can be used. According to the parallel processing, input data of a batch job is divided in accordance with a predetermined rule or the like, and the job steps are executed in parallel by using the divided data.

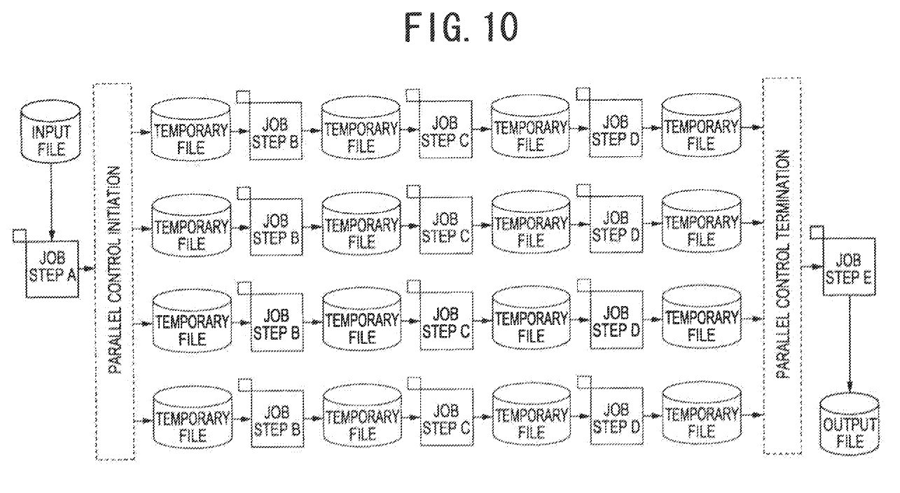

As an example, suppose that definitions as shown in FIG. 3 are made in a JCL file. According to the JCL file, input data is divided in accordance with a rule defined in control statements (third to fifth lines) for controlling data division. Parallel processing control is performed for job steps between a control statement (second line) for initiating control of the parallel processing and a control statement (ninth line) for terminating control of pipe processing, or more specifically, job steps B (“Step B” in the sixth line) to D (“Step D” in the eighth line). The number of parallel job steps for parallel arrangements is defined in a JCL execution instruction. When the number of job steps for parallel arrangements is set to, for example, four, processing is executed as shown in FIG. 10. More specifically, the job steps B to D are executed in four parallel arrangements.

Even in such parallel processing, there remains a similar problem as in the pipe processing described above that the process efficiency is degraded in the event that the number of processes exceeds the computer processing capacity. However, improvements in both the high speed and stability of batch processing can be accomplished in the manner that parallel processing is executed only within the range of the maximum number of processes synchronously executable in the server.

What is claimed is:

1. A computer-readable storage medium having stored thereon a batch processing program for causing a computer to provide functions including:
reading means for reading a batch job definition file;
determining means for determining a maximum number of processes representing a number of job steps defined in the batch job definition file as pipe processing objects in the batch job definition file to be synchronously executable;
first executing means for executing job steps in a manner that, when the number of job steps is determined by the determining means to exceed the maximum number of processes, successive job steps defined as pipe processing objects are divided in units of a maximum number of job steps corresponding to the maximum number of processes, wherein a pipe is used for data transfer between respective job steps within a same segment divided, and a temporary file is used for data transfer between each set of adjacent job steps each belonging to a different segment; and
second executing means for executing job steps in a manner that, when the number of job steps is determined by the determining means to not exceed the maximum number of processes, a pipe is used for data transfer between respective job steps of all of the successive job steps defined as the pipe processing objects.

2. A computer-readable storage medium having stored thereon a batch processing program according to claim 1, wherein the batch processing program causes the first executing means to generate an input and output table defining each input or output to be a pipe or a temporary file for each job step, and to sequentially execute the each job step.

3. A computer-readable storage medium having stored thereon a batch processing program according to claim 1 or 2, wherein the batch processing program causes the determining means to perform determination in accordance with the maximum number of processes that is dynamically rewritten corresponding to an operational status of the computer.

4. A computer-readable storage medium having stored thereon a batch processing program according to claim 1 or 3, wherein the batch processing program causes the first executing means to provide functions including:
a function for reading an input object name or an output object name for each job step defined in the batch job definition file;
a function for generating a pipe or temporary file to be used for a data input or a data output for the each job step in the input object name or the output object name;
a function for setting the input object name or the output object name to an environmental variable indicative of an input object or an output object in a process of executing the each job step; and
a function for correlating the input object or the output object for the each job step to the pipe or the temporary file.

5. A batch processing method for causing a computer to execute steps including:
a reading step of reading a batch job definition file;
a determining step of determining a maximum number of processes representing a number of job steps defined in the batch job definition file as pipe processing objects in the batch job definition file to be synchronously executable;
a first executing step of executing job steps in a manner that, when the number of job steps is determined by the determining step to exceed the maximum number of processes, successive job steps defined as pipe processing objects are divided in units of a maximum number of job steps corresponding to the maximum number of processes, wherein a pipe is used for data transfer between respective job steps within a same segment divided, and a temporary file is used for data transfer between each set of adjacent job steps each belonging to a different segment; and
a second executing step of executing job steps in a manner that, when the number of job steps is determined by the determining step to not exceed the maximum number of processes, a pipe is used for data transfer between respective job steps of all of the successive job steps defined as the pipe processing objects.

6. A batch processing apparatus comprising:
a batch job definition file;
storing means having stored thereon a maximum number of processes synchronously executable;
reading means for reading the batch job definition file;
determining means for determining whether or not a number of job steps defined in the batch job definition file as pipe processing objects in the batch job definition file exceeds the maximum number of processes stored in the storing means;
first executing means for executing job steps in a manner that, when the number of job steps is determined by the determining means to exceed the maximum number of processes, successive job steps defined as pipe processing objects are divided in units of a maximum number of job steps corresponding to the maximum number of processes, wherein a pipe is used for data transfer between respective job steps within a same segment divided, and a temporary file is used for data transfer between each set of adjacent job steps each belonging to a different segment; and
second executing means for executing job steps in a manner that, when the number of job steps is determined by the determining means to not exceed the maximum number of processes, a pipe is used for data transfer between respective job steps of all of the successive job steps defined as the pipe processing objects.
